(19) United States
(12) Patent Application Publication
(10) Pub. No.: US 2025/0052974 A1
(43) Pub. Date: Feb. 13, 2025

(54) OPTICAL FIBER FEEDTHROUGH FOR A VACUUM CHAMBER

(71) Applicant: Max-Planck-Gesellschaft zur Foerderung der Wissenschaften e. V., Muenchen (DE)

(72) Inventors: Wolfgang ZEIDNER, Garching (DE); Moritz GRUBER, Garching (DE); Karlheinz KAUNERT, Garching (DE)

(21) Appl. No.: 18/799,012

(22) Filed: Aug. 9, 2024

(30) Foreign Application Priority Data
Aug. 9, 2023 (DE) 102023121227.3

(51) Int. Cl. G02B 6/44

(52) U.S. Cl. CPC G02B 6/44775

(57) ABSTRACT

Disclosed is an optical fiber feedthrough (10) configured to feed through optical fibers (1) between an interior and exterior of evacuable vacuum chamber (30). The feedthrough includes at least one mounting flange (11a, 11b) configured for pressure-tight fastening to vacuum chamber and includes passage openings (12a, 12b) configured for pressure-tightly receiving a respective optical fiber. The passage openings are each provided with a sealing receptacle (13a, 13b) and a sealing element (14a, 14b) arranged therein for pressure-tightly receiving the respective optical fiber. A compression device (15a, 15b) is connected to each mounting flange, which is configured to compress the respective sealing elements axially along the respective passage openings. Also disclosed is an optical fiber assembly (20) including the feedthrough and optical fibers, and a method for passing a plurality of optical fibers between an interior and exterior of an evacuable vacuum chamber using the aforementioned feedthrough.

### BACKGROUND

The invention relates to an optical fiber feedthrough for feeding through a plurality of optical fibers between an interior of an evacuable vacuum chamber and an exterior of the vacuum chamber. The invention also relates to an optical fiber assembly having such an optical fiber feedthrough and to a method for feeding through a plurality of optical fibers between an interior of an evacuable vacuum chamber and an exterior of the vacuum chamber using such an optical fiber feedthrough.

In order to transmit optical signals between the interior of a vacuum device and an exterior, corresponding feed-through flanges are known in the state of the art. One approach, for example, is to position fiber optic cables in through holes of a vacuum flange and firmly connect them to the flange using epoxy resin adhesives. The disadvantage of this is that the fixed and inflexible connections often leak over time or as a result of bake-out processes and the flanges, together with the fiber optic cables, have to be replaced.

Furthermore, DE 11 2019 006 860 T5 discloses a flange with a radially compressed elastomer gasket through which an optical fiber is passed. The disadvantage of this is that only a limited sealing effect can be achieved by the radially compressed gasket and a high radial pressure can be exerted on the optical fiber, which can lead to transmission losses.

### OBJECTIVE OF THE INVENTION

Therefore, the object of the invention is to provide an improved solution for feeding through a plurality of optical fibers into or out of a vacuum chamber, by means of which disadvantages of previous approaches can be avoided. In particular, it is an object of the invention to provide a solution which allows a tight feed through of a plurality of optical fibers and preferably has low transmission losses in the optical fibers.

### BRIEF SUMMARY OF THE INVENTION

These tasks are solved by an optical fiber feedthrough, an optical fiber assembly and a method of the invention, as explained in greater detail in the following description with partial reference to the figures.

According to a first independent aspect of the disclosure, an optical fiber feedthrough is provided. Preferably, the optical fiber feedthrough is configured to feed through a plurality of optical fibers (e.g. single-mode optical fibers and/or multi-mode optical fibers) between an interior (e.g. chamber inner space) of an evacuable vacuum chamber (evacuable space, e.g. ultrahigh vacuum chamber) and an (e.g. outer) exterior of the vacuum chamber.

The optical fiber feedthrough comprises at least one mounting flange (e.g. a CF flange), which is configured for, preferably pressure-tight, fastening to the vacuum chamber, and comprises a plurality of passage openings (e.g. through holes, in particular counterbored holes). The passage openings are, in turn, each configured for, preferably pressure-tight, receiving a respective optical fiber of the plurality of optical fibers. For example, each of the passage openings (of the plurality of passage openings) can be assigned to a respective optical fiber (of the plurality of optical fibers) and/or comprise an opening cross-section adapted to the respective optical fiber.

It is further provided that the passage openings are each provided with a sealing receptacle and a sealing element (e.g. a metal O-ring and/or Viton O-ring). Preferably, the (respective) sealing element is arranged in the (respective) sealing receptacle for, preferably pressure-tightly, receiving the respective optical fiber.

It is further provided that a compression device (e.g. a clamping device) is connected, preferably detachably, to each mounting flange. The compression device is configured to compress the respective sealing elements (e.g. axially) along the respective passage openings, preferably in order to thereby cause a radial expansion and/or a, relative to the respective passage opening, transverse expansion of the respective sealing elements. Preferably, the compression device should thus be configured to compress the respective sealing elements (e.g. axially) along the respective passage openings in order to thereby exert a radially inwardly directed compressive and/or clamping force on the respective optical fibers. For example, the (respective) compression device may comprise a compression plate (e.g. fastened to the respective mounting flange), by means of which, for example, the (axial) compression and/or clamping force can be generated. Furthermore, the (respective) compression device may also comprise, for example, a plurality of interposed sleeves (each of which may, for example, be arranged between the compression plate and one of the sealing elements). For example, the (axial) compression and/or clamping force of the compression plate may be supplied to the respective sealing elements by the interposed sleeves. Preferably, each mounting flange comprises (only) one such compression device, which is preferably associated with several of the sealing elements. Accordingly, the respective compression device may be configured for (simultaneously) compressing several or all sealing elements of the respective mounting flange.

Advantageously, an optical fiber feedthrough can thus be provided, which enables a pressure-tight accommodation of the optical fibers. By means of the compression device, a preferably adjustable axial compression and/or clamping force may be exerted on the respective sealing elements, causing them to expand in a radial direction and circumferentially seal the respective optical fibers. In addition to adjusting the respective compression and/or clamping force, the (detachable) compression device also advantageously facilitates the maintenance or replacement of optical fibers, since the compression device offers better accessibility than individually compressed seals in the respective passage openings.

According to one aspect, the at least one mounting flange may comprise a first mounting flange and a second mounting flange. The first mounting flange may also be referred to as a vacuum flange, and the second mounting flange may also be referred to as an atmospheric flange. Preferably, the first mounting flange or vacuum flange is configured for (e.g. pressure-tight) fastening to the vacuum chamber. For example, the first mounting flange may be attached to an opening of the vacuum chamber (e.g. a flange of the vacuum chamber corresponding to the vacuum flange) by a screw connection. For this purpose, the first mounting flange may comprise, for example, a mounting flange hole circle with holes for receiving fastening elements.

Furthermore, the second mounting flange or atmospheric flange may be, preferably pressure-tightly, fastened to the first mounting flange. For example, the first and second mounting flange may be screwed together. For this purpose, the first mounting flange (possibly in addition to the mounting flange hole circle) may, for example, comprise a first hole circle with several first holes and the second mounting flange may comprise a second hole circle with several second holes, wherein screw elements are guided through the first and second holes in pairs. Alternatively, the first and second mounting flanges may also be integrally connected to each other, e.g. by being manufactured using 3D printing. Preferably, the first and second mounting flanges are spaced apart from each other at least in sections, in particular in the section of the respective passage openings, preferably in such a way that an evacuable gap is formed between the first and second mounting flanges. As will be described in more detail below, this advantageously allows the optical fibers to be fed through as pressure-tight and bend-free as possible.

According to a further aspect, passage openings of the first mounting flange of the plurality of passage openings (which may also be referred to as first passage openings for better differentiation) and passage openings of the second mounting flange (which may be referred to as second passage openings) may be aligned with each other. For example, the (first) passage openings of the first mounting flange and the (second) passage openings of the second mounting flange may be aligned with each other in pairs. Due to the double or spaced feed-through/support of the respective optical fibers, mechanical stresses (e.g. due to bending of the optical fibers) can be advantageously avoided as far as possible.

According to a further aspect, an evacuable gap (e.g. by means of a vacuum pump, in particular a rotary vane pump) may be provided between the first mounting flange and the second mounting flange. For example, the first and second mounting flange may delimit the evacuable gap (at least in sections). Preferably, the evacuable gap may be evacuated to at least pre-vacuum or fine vacuum. This may advantageously reduce the leakage rate at the respective passage openings and thus increase the tightness of the optical fiber feedthrough.

According to a further aspect, the optical fiber feedthrough may comprise a support device (e.g. a support plate). The support device (e.g. made of polyetheretherketone) may be arranged on sides of the vacuum chamber, preferably at a distance from the first mounting flange and/or at a distance from the compression plate of the first mounting flange. Preferably, the support device thus has a greater distance from the second mounting flange than from the first mounting flange. By way of example only, the support device may be fastened to the first mounting flange and/or to the compression plate of the first mounting flange via a spacer (e.g. a pipe section). Further, the support device may comprise a plurality of support openings, which are preferably aligned with the (first) passage openings of the first mounting flange and the (second) passage openings of the second mounting flange. For example, the support openings may each be aligned with the (first) passage openings of the first mounting flange, which in turn may be aligned with the (second) passage openings of the second mounting flange. In other words, the optical fibers may each be guidable or guided (e.g. in a straight line) through one of the support openings, one of the (first) passage openings of the first mounting flange, and one of the (second) passage openings of the second mounting flange. By providing the support device and thus a triple support of the optical fibers, movements of the optical fibers or mechanical loads on the optical fibers (e.g. due to bending) can be advantageously avoided as far as possible.

According to a further aspect, the optical fiber feedthrough may comprise a coupling device (e.g. an FC connector coupling device). The coupling device may be arranged on sides of the exterior of the vacuum chamber, preferably at a distance from the second mounting flange and/or at a distance from the compression plate of the second mounting flange. Preferably, the coupling device thus has a greater distance from the first mounting flange than from the second mounting flange. By way of example only, the coupling device may be fastened to the second mounting flange and/or to the compression plate of the second mounting flange via an extension (e.g. a hollow profile and/or housing section). Furthermore, the coupling device may comprise a plurality of optical fiber couplings (e.g. in the form of corresponding sockets and/or couplings) for connecting external optical fibers (e.g. for connecting external optical fiber connectors). By way of example only, optical fiber couplings may be configured as FC sockets or FC couplings. Preferably, the optical fiber couplings of the plurality of optical fiber couplings are aligned with the (first) passage openings of the first mounting flange and the (second) passage openings of the second mounting flange. For example, the optical fiber couplings may each be aligned with the (first) passage openings of the first mounting flange, which in turn may be aligned with the (second) passage openings of the second mounting flange. Advantageously, this allows for connecting external optical fiber connectors to the optical fiber feedthrough as easily as possible.

According to a further aspect, each compression device may comprise a compression plate (e.g. a steel plate). This may be fastened (e.g. screwed) to the respective mounting flange. In the event that the at least one mounting flange comprises a first and a second mounting flange, the optical fiber feedthrough may comprise, for example, a first compression device with a first compression plate fastened (e.g. screwed) to the first mounting flange and a second compression device with a second compression plate fastened (e.g. screwed) to the second mounting flange. The compression plate or the first and second compression plates may each comprise a plurality of through holes through which the optical fibers may pass or be passed.

In addition or alternatively, each compression device may comprise a plurality of interposed sleeves. Preferably, the plurality of interposed sleeves serves to transmit compressive force from the (respective) compression plate to the respective sealing element. Each of the interposed sleeves may be received and/or arranged in one of the passage openings of the respective mounting flange. In the event that the at least one mounting flange comprises a first and a second mounting flange, the first compression device may, for example, comprise a first plurality of interposed sleeves which are received in the respective passage openings of the first mounting flange and a second plurality of interposed sleeves which are received in the respective passage openings of the second mounting flange. Advantageously, this can ensure that the optical fibers are securely fixed.

According to a further aspect, a further sealing element and/or a further interposed sleeve may be arranged in each of the passage openings (e.g. in their respective sealing receptacles). Thus, in addition to the sealing element, which in this context may also be referred to as the first sealing element, a further sealing element, which may also be referred to as the second sealing element, may also be received or arranged in the (respective) sealing receptacles of the passage openings. By way of example only, the further or second sealing elements may each be configured as sealing rings (e.g. sealing O-rings). However, it is also possible that the further or second sealing elements each comprise two (e.g. metallic) end portions and a (e.g. deformable) sealing sleeve arranged between the two end portions, as will be described in more detail below.

In addition or alternatively, in addition to the interposed sleeve, a further interposed sleeve may also be received or arranged in the sealing receptacles of the passage openings. The respective further interposed sleeves may be part of the (respective) compression device. By providing corresponding double seals, the leakage rate at the respective passage openings can be advantageously reduced, thereby increasing the overall tightness of the optical fiber feedthrough.

According to a further aspect, each of the interposed sleeves may comprise a chamfer, preferably on a side of the respective interposed sleeve facing the respective sealing element. For example, each of the interposed sleeves may comprise a chamfered or beveled edge (e.g. at an angle of) 45°. Preferably, the respective chamfer serves to increase a (respective) contact surface between the interposed sleeves and the sealing elements (in contact with them). This can advantageously improve the tightness of the optical fiber feedthrough.

In addition or alternatively, each of the further interposed sleeves may also comprise a chamfer, which for better differentiation may be referred to as a further chamfer.

Preferably, each of the further interposed sleeves comprises the further chamfer on a further side of the respective further interposed sleeve facing the respective further sealing element. Accordingly, each of the further interposed sleeves can also comprise, for example, a beveled or chamfered (further) edge (e.g. at an angle of) 45°.

According to a further aspect, the respective sealing elements may comprise at least one of an elastomer and a metal. For example, the respective sealing elements may each be made of an elastomer (e.g. Viton) and/or metal (e.g. indium and/or copper and/or stainless steel).

According to a further aspect, the respective sealing elements may each comprise a sealing ring and/or be configured as a sealing ring. For example, the sealing elements and/or the sealing rings may each be configured as sealing O-rings and/or sealing C-rings. The sealing elements and/or sealing rings may thus comprise a closed (e.g. circumferential) and/or annular (e.g. circular) shape. Advantageously, this makes it possible to provide sealing elements that are easy and inexpensive to manufacture.

According to a further aspect, the respective sealing elements may each comprise two (e.g. metallic) end portions and a (e.g. deformable) sealing sleeve (e.g. made of polytetrafluoroethylene). The sealing sleeve is preferably arranged between the two end portions, preferably in such a way that the sealing sleeve is compressible (e.g. compressible) between the two end portions (e.g. by applying axial pressure to one of the end portions). Furthermore, the sealing sleeve preferably comprises a (e.g. circumferentially) closed (e.g. sleeve-shaped and/or hollow cylindrical) shape. Advantageously, these (e.g. multi-part) sealing elements can be used to provide a detachable and reusable solution for sealing the optical fibers.

In one embodiment, the sealing sleeve may be made of polytetrafluoroethylene.

In addition or alternatively, the sealing sleeve may be manufactured using 3D printing technology. For example, the sealing sleeve may be manufactured using additive manufacturing, e.g. by applying a material in layers.

In addition or alternatively, the sealing sleeve may have a substantially X-shaped cross-section (e.g. profile cross-section). For example, the sealing sleeve may comprise a substantially X-shaped profile perpendicular to a circumferential direction of the sealing sleeve. Advantageously, this shape allows for radial expansion of the sealing sleeve when axial pressure is applied, in order to exert a radially inwardly directed pressure and/or clamping force on the respective optical fibers.

In addition or alternatively, the end portions may each have an annular shape and/or a closed shape. For example, the (respective) end portions may each be configured as ring end portions.

In addition or alternatively, the end portions and/or ring end portions may each be wedge-shaped, at least in sections. For example, the end portions and/or ring end portions may comprise a tapered section, preferably on a side facing the sealing sleeve. For example, the end portions and/or ring end portions may each taper conically. Furthermore, the end portions and/or ring end portions, preferably their tapered or wedge-shaped sections, may engage in the sealing sleeve and/or be arranged in the sealing sleeve at least in sections, preferably in order to spread the sealing sleeve apart (e.g. radially) when axial pressure is applied to one of the end portions.

Regardless of the specific configuration of the sealing elements, these may be configured to expand and/or extend transversely (e.g. radially) along the respective passage openings in the event of (e.g. axial) loading (e.g. pressurization). Axial may be understood here, for example, as a direction running along a longest extension or direction of extension of the respective passage openings. Accordingly, the respective sealing elements may be compressible and/or squashable (e.g. axially).

Further, the disclosure relates to an optical fiber assembly. Preferably, the optical fiber assembly is configured for, preferably pressure-tight, fastening to a vacuum chamber (e.g. ultrahigh vacuum chamber).

The optical fiber feedthrough assembly comprises an optical fiber feedthrough as described herein. Consequently, the features described above in connection with the optical fiber feedthrough should also be disclosed and claimable in connection with the optical fiber assembly. The converse should also be true.

The optical fiber assembly further comprises a plurality of optical fibers. These are preferably each arranged and/or received in one of the passage openings. For example, each of the optical fibers may be guided, preferably in a straight line, through one of the first passage openings of the first mounting flange and one of the second passage openings of the second mounting flange. Preferably, each of the passage openings is thus associated with one, preferably exactly one, optical fiber of the plurality of optical fibers. Accordingly, the number of optical fibers may be equal to the number of passage openings. However, as will be described in more detail below, the number of optical fibers may also be different from the number of passage openings.

According to one aspect, the optical fibers of the plurality of optical fibers may each comprise a metal sheath in the portion of the optical fiber feedthrough. For example, the respective optical fibers may each be sheathed with metal (e.g. stainless steel) at least in sections in the region of the optical fiber feedthrough. The respective metal sheath may, for example, be configured in the form of a metal sleeve (e.g. in the form of a stainless steel tube), which may, for example, be bonded to the respective optical fiber (e.g. using epoxy resin). Alternatively, the respective metal sheath may also be soldered to the respective optical fiber, for which purpose a metal coating is applied to the respective optical fiber (e.g. in sections, in particular in a section where the metal sleeve is to be attached). In the event that the at least one mounting flange comprises a first and a second mounting flange, the optical fibers of the plurality of optical fibers may comprise two metal sheath sections, preferably spaced apart from each other. These may be arranged, for example, in the portions of the first mounting flange and the second mounting flange on the respective optical fibers. Overall, a good seal to the respective sealing elements can be advantageously achieved by the aforementioned metal sheathing. Furthermore, pressure loads on the actual optical fibers and thus transmission losses can be reduced.

In one embodiment, the respective metal sheath and/or the respective metal sheath sections may each be chamfered, preferably in order to facilitate insertion of the optical fibers into the optical fiber feedthrough (e.g. with the aid of some vacuum grease). For example, the respective metal sheath and/or the respective metal sheath sections can each comprise a 60° chamfer.

According to a further aspect, no optical fibers may be arranged in a passage opening subset of the plurality of passage openings. For example, the number of optical fibers may be less than the number of passage openings or less than the number of first or second passage openings. Blind plugs, preferably pressure-tight blind plugs, may be arranged in the passage opening subset or the passage openings of the passage opening subset (instead of the actual optical fibers). Accordingly, the optical fiber assembly may further comprise one or more such blind plugs. The blind plugs may be adapted in their shape and/or size to the actual optical fibers to be accommodated and/or, except for the material used, be identical in construction to the actual optical fiber to be accommodated.

The disclosure further relates to a method. Preferably, the method is for feeding through a plurality of optical fibers between an interior of an evacuable vacuum chamber and an (e.g. external) exterior of the vacuum chamber. Here, the optical fiber feedthrough as described herein is used.

The method comprises positioning the optical fibers of the plurality of optical fibers (and/or blind plugs) in the passage openings of the at least one mounting flange. For example, this may be done by manually inserting the optical fibers (and/or blind plugs) into the respective passage openings.

The method further comprises compressing the sealing elements in the sealing receptacles of the passage openings (e.g. axially) along the respective passage opening. Preferably, this is done by the compression device. For example, the axial compression may be achieved by screwing the compression plate (e.g. plane-parallel) to the respective mounting flange to generate an axial clamping force, which can be transmitted to the sealing elements through the interposed sleeves received in the passage openings.

Preferably, the method also comprises evacuating the vacuum chamber, e.g. with a suitable vacuum pump (e.g. turbomolecular pump).

The embodiments and features described above may be combined with one another.

### BRIEF DESCRIPTION OF THE DRAWINGS

Further details and advantages are described below with reference to the accompanying figures.

FIG. 1: shows a schematic representation of an optical fiber feedthrough according to an embodiment in a state mounted on a vacuum chamber;

FIG. 2: shows a front view of the optical fiber feedthrough of FIG. 1;

FIG. 3: shows a sectional view of the optical fiber feedthrough along the sectional line A-A marked in FIG. 2;

FIG. 4: shows a detailed view of portion C of the optical fiber feedthrough marked in FIG. 3;

FIG. 5: shows a sectional view of the optical fiber feedthrough along the sectional line B-B marked in FIG. 2;

FIG. 6: shows a detailed view of a sealing receptacle of an optical fiber feedthrough according to an embodiment;

FIG. 7: shows a detailed view of a sealing element according to an embodiment;

FIG. 8: shows a sectional view of the sealing element along the sectional line A-A marked in FIG. 7;

FIG. 9: shows a schematic representation of an optical fiber feedthrough according to another embodiment;

FIG. 10: shows a sectional view of the optical fiber feedthrough of FIG. 9;

FIG. 11: shows a side view of the optical fiber feedthrough of FIG. 9;

FIG. 12: shows a detailed view of a mounting flange according to an embodiment;

FIG. 13: shows a partially transparent side view of the mounting flange of FIG. 12;

FIG. 14: shows a sectional view of the mounting flange along the sectional line C-C marked in FIG. 13;

FIG. 15: shows a sectional view of the mounting flange along the sectional line B-B marked in FIG. 13;

FIG. 16: shows a sectional view of the mounting flange along the sectional line A-A marked in FIG. 13;

FIG. 17: shows a sectional view of a mounting flange according to a further embodiment;

FIG. 18: shows a further sectional view of the mounting flange of FIG. 17;

FIG. 19: shows an isometric view of the mounting flange of FIG. 17;

FIG. 20: shows an illustration of an optical fiber feedthrough according to a further embodiment; and

FIG. 21: shows a side view of the optical fiber feedthrough of FIG. 20.

### DETAILED DESCRIPTION OF PREFERRED EMBODIMENTS OF THE INVENTION

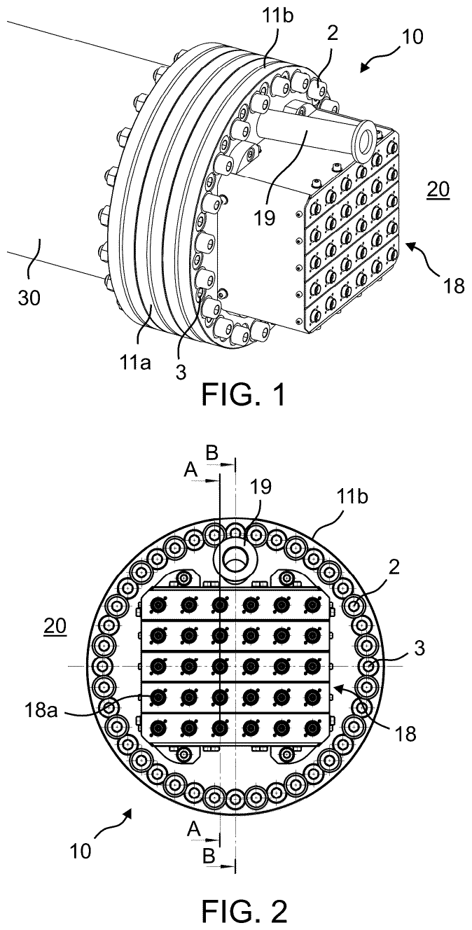

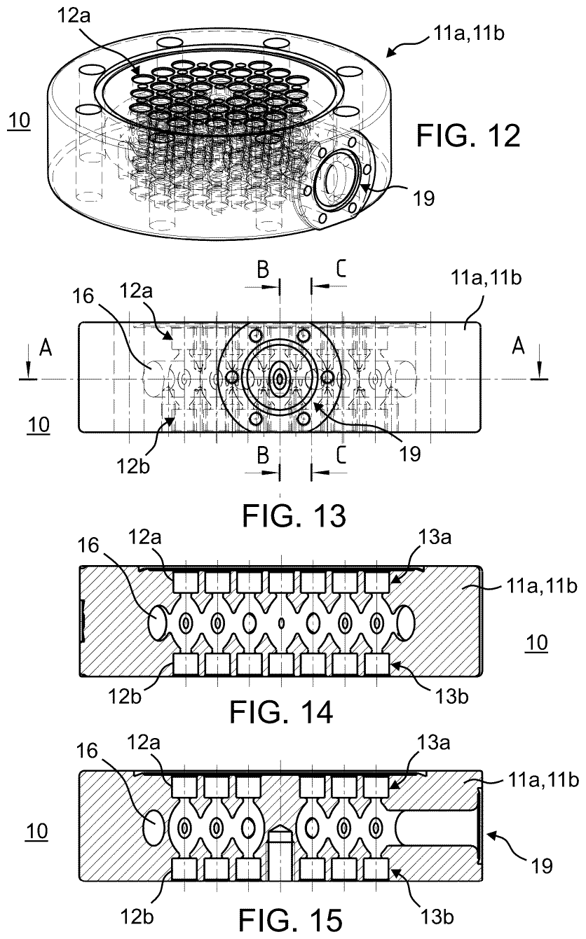

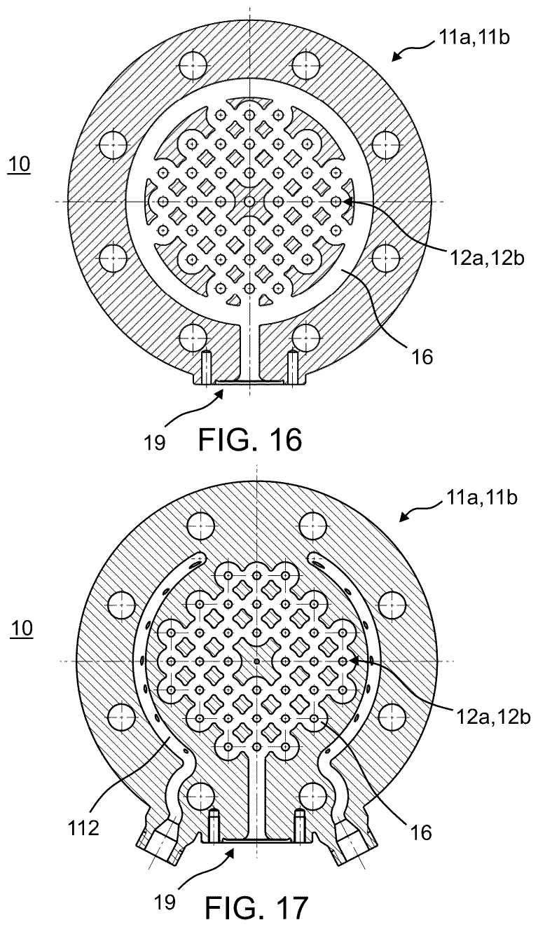

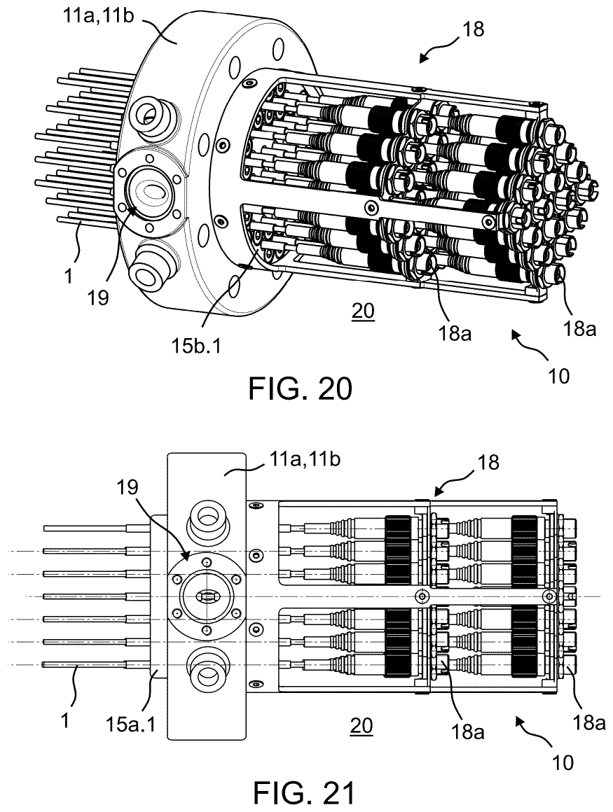

The embodiments shown in FIGS. 1 to 21 are at least partially identical, so that similar or identical parts are provided with the same reference signs and reference is also made to the description of the other embodiments or figures in order to avoid repetition.

FIGS. 1 to 21 each show, at least in part, an optical fiber feedthrough 10 for a vacuum chamber 30. The optical fiber feedthrough 10 can thus be mounted on a vacuum chamber 30, for example by flanging it onto a (standardized) vacuum flange (e.g. CF flange) of the vacuum chamber 30, as shown in FIG. 1 as an example.

The optical fiber feedthrough 10 is preferably configured to feed through a plurality of optical fibers 1 between an interior of an evacuable vacuum chamber 30 and an (e.g. external) exterior of the vacuum chamber 30. The optical fiber feedthrough 10 may further be configured to guide light or optical signals (via the respective optical fibers 1) through a pressure-tight wall or boundary of the vacuum chamber 30.

The optical fiber feedthrough 10 comprises at least one mounting flange 11a, 11b, comprising a plurality of passage openings 12a, 12b, each of which is provided with a sealing receptacle 13a, 13b and at least one sealing element 14a, 14b, and at least one compression device 15a, 15b.

The at least one mounting flange 11a, 11b (e.g. made of VA) may be configured for, preferably pressure-tight, fastening to the vacuum chamber 30. For example, the at least one mounting flange 11a, 11b may be configured as a CF flange according to ISO 3669:2017. The at least one mounting flange 11a, 11b may comprise a sealing surface (not expressly shown) which may be configured to correspond to a sealing surface of the vacuum flange of the vacuum chamber 30. The sealing surfaces of the at least one mounting flange 11a, 11b may, for example, be configured to receive a seal (e.g. in the form of an O-ring) and/or comprise a cutting edge (not shown). For example, the at least one mounting flange 11a, 11b or its sealing surface may be configured to receive a metal sealing ring (e.g. copper sealing ring), into which the cutting edge of the at least one mounting flange 11a, 11b is pressed when the at least one mounting flange 11a, 11b is mounted to the vacuum chamber 30.

Furthermore, the at least one mounting flange 11a, 11b for fastening to the vacuum chamber 30 may comprise a mounting flange hole circle for receiving fastening elements 2 (e.g. threaded bolts) (see e.g. FIGS. 1-3). The mounting flange hole circle may be configured to correspond to a vacuum flange hole circle of the vacuum flange of the vacuum chamber 30. Accordingly, a number and arrangement of holes of the mounting flange hole circle of the at least one mounting flange 11a, 11b may correspond to a number and arrangement of holes of the vacuum flange hole circle of the vacuum chamber 30. The optical fiber feedthrough 10 may be fixed to the vacuum chamber 30 by inserting fastening elements 2 through a hole of the mounting flange hole circle of the at least one mounting flange 11a, 11b and a hole of the vacuum flange hole circle of the vacuum chamber 30 respectively, and then tightening or securing the fastening elements 2 (e.g. with nuts).

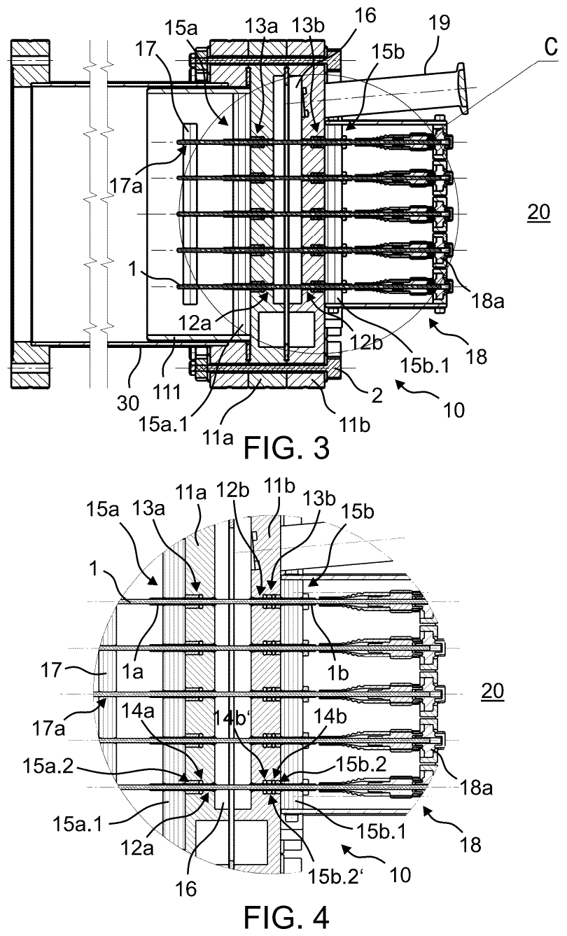

As mentioned above, the at least one mounting flange 11a, 11b comprises a plurality of passage openings 12a, 12b (e.g. in the form of through holes), which preferably serve to receive the optical fibers 1 (see e.g. FIGS. 3, 4 and 5). Accordingly, the passage openings 12a, 12b or their respective opening cross section may each be adapted to a shape, size and/or contour of the optical fibers 1 to be received or received. The number of passage openings 12a, 12b may vary depending on the flange size. For example, in case that the at least one mounting flange 11a, 11b is configured as a CF160 mounting flange, the optical fiber feedthrough 10 may comprise at least thirty, preferably at least sixty, passage openings 12a, 12b or optical fiber passages for 1500 μm optical fibers. In the event that the at least one mounting flange 11a, 11b is configured as a CF63 mounting flange, the optical fiber feedthrough 10 may comprise, for example, at least thirty-five passage openings 12a, 12b or optical fiber passages for 470 μm optical fibers.

The passage openings 12a, 12b may (completely) penetrate the at least one mounting flange 11a, 11b. Accordingly, the passage openings 12a, 12b may connect the interior of the vacuum chamber 30 and the (e.g. outer) exterior of the vacuum chamber 30. Preferably, the passage openings 12a, 12b are each configured to receive (e.g. in a pressure-tight manner) one optical fiber 1 of the plurality of optical fibers 1. Thus, one of the optical fibers 1 may be accommodated and/or arranged in each of the passage openings 12a, 12b. The optical fibers 1 may be passed through the at least one mounting flange 11a, 11b via the passage openings 12a, 12b. The optical fiber feedthrough 10 together with the corresponding optical fibers 1 may form an optical fiber assembly 20.

Each of the passage openings 12a, 12b comprises a sealing receptacle 13a, 13b and a sealing element 14a, 14b (see e.g. FIG. 4). Accordingly, the optical fiber feedthrough 10 may comprise a plurality of sealing receptacles 13a, 13b and a plurality of sealing elements 14a, 14b. Preferably, each of the sealing elements 14a, 14b is arranged in a respective one of the sealing receptacles 13a, 13b, preferably for pressure-tightly receiving of the optical fiber 1 guided through the respective passage openings 12a, 12b. For example, the respective sealing receptacles 13a, 13b may be configured as a section of the respective passage openings 12a, 12b. Preferably, the sealing receptacles 13a, 13b or the respective sections comprise a widened (opening) cross section compared to the remaining passage opening 12a, 12b.

The sealing elements 14a, 14b may, for example, be configured as sealing rings and/or each comprise a sealing ring (see, for example, FIGS. 4 and 6). The sealing elements 14a, 14b or sealing rings may be made of an elastomer (such as Viton) and/or of a metal alloy. The sealing elements 14a, 14b may have a circumferentially closed and/or annular (e.g. circular) shape. The sealing elements 14a, 14b may have a solid cross section or be made of a solid material. For example, the sealing elements 14a, 14b may be configured as O-rings. However, it is also possible that the sealing elements 14a, 14b comprise an open cross-section. For example, the sealing elements 14a, 14b may also be configured as C-rings.

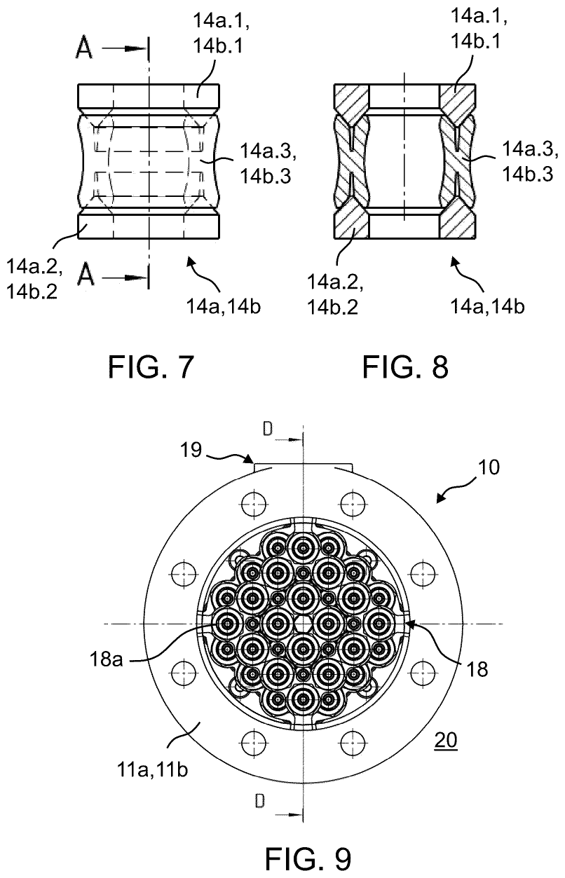

In addition or alternatively, the sealing elements 14a, 14b may also be configured as a plurality of parts. For example, the sealing elements 14a, 14b may comprise two (e.g. metallic) end portions 14a.1, 14a.2, 14b.1, 14b.2 and a (e.g. flexible) sealing sleeve 14a.3, 14b.3 (see FIGS. 7 and 8). The end portions 14a.1, 14a.2, 14b.1, 14b.2 may each be configured in an annular shape and/or comprise a closed shape. Parts of the end portions 14a.1, 14a.2, 14b.1, 14b.2 may be configured to be wedge-shaped and/or tapered. Preferably, the wedge-shaped and/or tapered parts protrude from the end portions 14a.1, 14a.2, 14b.1, 14b.2. For example, the end portions 14a.1, 14a.2, 14b.1, 14b.2 may each be configured as a ring (e.g. metal ring) with a flat upper side and a wedge-shaped and/or tapered lower side. Preferably, the end portions 14a.1, 14a.2, 14b.1, 14b.2 serve to distribute (e.g. uniformly) an external pressure to the sealing sleeve 14a.3, 14b.3. Accordingly, the end portions 14a.1, 14a.2, 14b.1, 14b.2 may also be referred to as plungers in this context.

The sealing sleeve 14a.3, 14b.3 is preferably arranged between the two end portions 14a.1, 14a.2, 14b.1, 14b.2. The two end portions 14a.1, 14a.2, 14b.1, 14b.2 may thus be connected to each other via the sealing sleeve 14a.3, 14b.3. The sealing sleeve 14a.3, 14b.3 may be configured to be (e.g. elastically) deformable and/or flexible. For example, the sealing sleeve 14a.3, 14b.3 may be made of polytetrafluoroethylene. However, it is also possible that the sealing sleeve 14a.3, 14b.3 is made of metal or a metal alloy. For example, the sealing sleeve 14a.3, 14b.3 may be made of stainless steel and/or stainless steel-copper and may comprise a silver coating. Furthermore, the sealing sleeve 14a.3, 14b.3 may comprise a substantially X-shaped cross-section (e.g. profile cross-section). In this case, the two end portions 14a.1, 14a.2, 14b.1, 14b.2, preferably their wedge-shaped and/or tapered parts, may each engage in notches formed by legs of the X-shaped cross-section. Accordingly, each of the two end portions 14a.1, 14a.2, 14b.1, 14b.2 may bear against the sealing sleeve 14a.3, 14b.3 or be in direct mechanical contact, preferably via several (e.g. spatially separated) abutment surfaces. By applying pressure to one or both end portions 14a.1, 14a.2, 14b.1, 14b.2 (e.g. externally) in the axial direction, the sealing sleeve 14a.3, 14b.3 may be spread apart transversely to the axial direction (e.g. radially). For example, the sealing sleeve 14a.3, 14b.3 may be configured to deform inwardly and outwardly (e.g. elastically) due to the axial pressure of the two end portions 14a.1, 14a.2, 14b.1, 14b.2.

As mentioned above, the optical fiber feedthrough 10 further comprises a compression device 15a, 15b (see, for example, FIGS. 3, 4 and 5). This may be connected (e.g. detachably) to the at least one mounting flange 11a, 11b. For example, the compression device 15a, 15b may be screwed to the at least one mounting flange 11a, 11b and/or otherwise positively and/or non-positively attached to the at least one mounting flange 11a, 11b. The compression device 15a, 15b is configured to compress the sealing elements 14a, 14b axially along the respective passage openings 12a, 12b. For example, the compression device 15a, 15b may be configured to exert a clamping and/or compressive force on the sealing elements 14a, 14b oriented along the respective passage openings 12a, 12b. Preferably, the compression device 15a, 15b is configured to exert an adjustable (axial) clamping and/or compressive force (e.g. via the screw connection with the at least one mounting flange 11a, 11b) on the sealing elements 14a, 14b. The clamping and/or compressive force, which may also be referred to as pressing force, may be directed towards the inside of the at least one mounting flange 11a, 11b. Radial expansion of the sealing elements 14a, 14b may be induced by the axial compression, preferably in order to clamp the respective optical fibers 1 (received in the passage openings 12a, 12b) radially or circumferentially.

In this context, the compression device 15a, 15b may, for example, comprise a compression plate 15a.1, 15b.1 (e.g. a steel plate), which may be fastened (e.g. detachably) to the at least one mounting flange 11a, 11b (see, for example, FIGS. 3, 4 and 5). For example, the compression plate 15a.1, 15b.1 may be screwed to the at least one mounting flange 11a, 11b by means of a plurality of cylinder head screws. Preferably, the compression plate 15a.1, 15b.1 is configured to exert the pressing force (simultaneously) on several of the sealing elements 14a, 14b and/or to distribute the pressing force as evenly as possible over several of the sealing elements 14a, 14b.

The compression plate 15a.1, 15b.1 may be made of metal or a metal alloy. For example, the compression plate 15a.1, 15b.1 may comprise aluminum, stainless steel, steel, brass and/or copper. In addition or alternatively, however, it is also possible for the compression plate 15a.1, 15b.1 to be made of ceramic, PEEK and/or Vespel.

The compression plate 15a.1, 15b.1 may comprise a plurality of through holes. The through holes may serve to feed through the plurality of optical fibers 1 or the optical fibers 1 may be received in the through holes. The plurality of through holes of the compression plate 15a.1, 15b.1 may be aligned with the plurality of passage openings 12a, 12b of the at least one mounting flange 11a, 11b. For example, the through holes of the compression plate 15a.1, 15b.1 and the passage openings 12a, 12b of the at least one mounting flange 11a, 11b may be aligned in pairs, preferably in such a way that one of the optical fibers 1 can be passed in a straight line through one of the through holes and one of the passage openings 12a, 12b.

The compression device 15a, 15b may further comprise a plurality of interposed sleeves 15a.2, 15b.2 (see, for example, FIG. 4). The interposed sleeves 15a.2, 15b.2 may each be made of metal and/or a metal alloy, for example. For example, the interposed sleeves 15a.2, 15b.2 may be made of brass and/or stainless steel. Preferably, the interposed sleeves 15a.2, 15b.2 transmit the clamping and/or compressive force from the compression plate 15a, 15b to the respective sealing elements 14a, 14b. For this purpose, one of the interposed sleeves 15a.2, 15b.2 may be arranged in each of the passage openings 12a, 12b. Each of the interposed sleeves 15a.2, 15b.2 may thus be arranged between the compression plate 15a.1, 15b.1 and one of the sealing elements 14a, 14b. For example, each of the interposed sleeves 15a.2, 15b.2 may comprise a first end which is supported in each case on one of the sealing elements 14a, 14b, and a second end which is supported in each case on the compression plate 15a.1, 15b.1. Furthermore, each of the interposed sleeves 15a.2, 15b.2 may comprise (e.g. at its first end) a chamfer 15f (see FIG. 6). For example, each of the interposed sleeves 15a.2, 15b.2 may be beveled (e.g. at its first end). By means of the corresponding chamfers 15f, the respective faces on which the respective sealing elements 14a, 14b (on the respective interposed sleeves 15a.2, 15b.2) abut may be enlarged. Furthermore, the respective number of sealing surfaces (e.g. from four to three) may be reduced by the respective chamfers 15f. Additionally or alternatively, it is also possible that the passage openings 12a, 12b and/or the sealing receptacles 13a, 13b comprise corresponding chamfers or beveled portions into which, for example, the sealing elements 14a, 14b may be pressed or are pressed.

To improve tightness, the optical fiber feedthrough 10 and/or the compression device 15a, 15b may further comprise a plurality of further sealing elements 14b′ (see, for example, FIG. 4). Each of the passage openings 12a, 12b may be provided with one of the further sealing elements 14b′ of the plurality of further sealing elements 14b′. That is, each of the passage openings 12a, 12b may comprise a further sealing element 14b′ in addition to the sealing element 14a, 14b. However, it is also possible that only some of the passage openings 12a, 12b comprise corresponding further sealing elements 14b′. Preferably, each of the further sealing elements 14b′ is arranged in a respective one of the sealing receptacles 13a, 13b, preferably for pressure-tightly receiving of the optical fiber 1 guided through the respective passage openings 12a, 12b. The further sealing elements 14b′ may also have the characteristics of the sealing elements 14a, 14b. For example, the further sealing elements 14b′ may also be made of an elastomer (such as Viton) and/or of a metal alloy and/or be configured as O-rings and/or C-rings. The further sealing elements 14b′ may be configured in the same way as the sealing elements 14a, 14b. For example, the sealing elements 14a, 14b and the further sealing elements 14b′ may be identical parts. However, the further sealing elements 14b′ and the sealing elements 14a, 14b may also be configured differently, e.g. made of different materials.

The optical fiber feedthrough 10 and/or the compression device 15a, 15b may further comprise a plurality of further interposed sleeves 15b.2′ (see, for example, FIG. 4). In this case, each of the passage openings 12a, 12b may be provided with one of the further interposed sleeves 15b.2′ of the plurality of further interposed sleeves 15b.2′. In other words, each of the passage openings 12a, 12b may comprise a further interposed sleeve 15b.2′ in addition to the interposed sleeve 15b.2. However, it is also possible that only some of the passage openings 12a, 12b comprise corresponding further interposed sleeves 15b.2′. The further interposed sleeves 15b.2′ may each be arranged between a sealing element 14a, 14b and a further sealing element 14b′. For example, each of the further interposed sleeves 15b.2′ may be supported in each case on one of the sealing elements 14a, 14b and one of the further sealing elements 14b′. The further interposed sleeves 15b.2′ may generally have the characteristics of the interposed sleeves 15a.2, 15b.2, e.g. be made of metal and/or a metal alloy and/or each comprise a (further) chamfer 15f′. Furthermore, the further interposed sleeves 15b.2′ and the interposed sleeves 15a.2, 15b.2 may be identical or configured as identical parts. However, the further interposed sleeves 15b.2′ and the interposed sleeves 15a.2, 15b.2 may also be configured differently, e.g. be made of different materials.

In one embodiment, the at least one mounting flange 11a, 11b comprises a first mounting flange 11a (e.g. in the form of a CF flange) and a second mounting flange 11b (e.g. in the form of a CF flange) (see e.g. FIGS. 1 to 5). Accordingly, the at least one mounting flange 11a, 11b may be configured as a double flange. The first mounting flange 11a and the second mounting flange 11b may be fastened (e.g. detachably) to each other (e.g. screwed together). For this purpose, the first mounting flange 11a may comprise a first hole circle having a plurality of first holes and the second mounting flange 11b may comprise a second hole circle having a plurality of second holes. Preferably, a number and arrangement of the first holes of the first hole circle correspond to a number and arrangement of the second holes of the second hole circle. For example, the first and second holes may be arranged in pairs in alignment with each other.

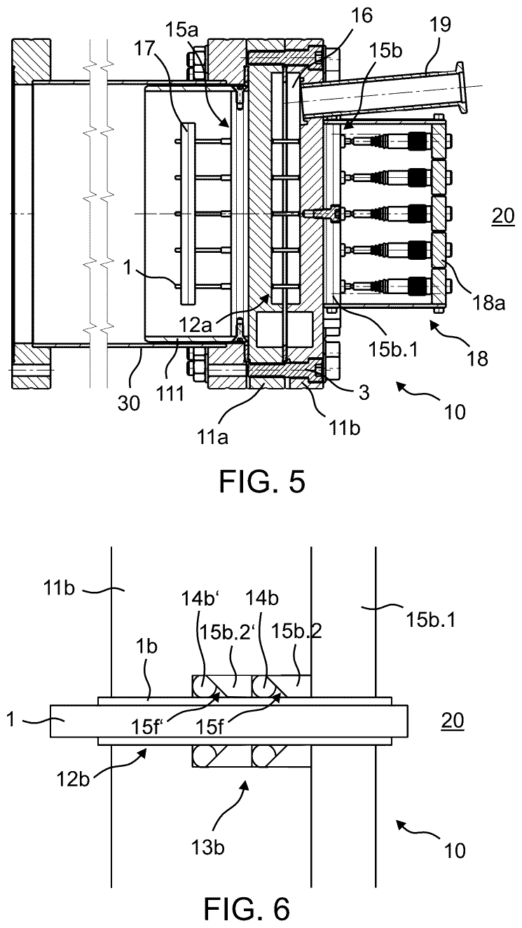

The respective first holes of the first mounting flange 11a may each comprise an (internal) thread. Furthermore, the respective second holes of the second mounting flange 11a may each comprise an abutment surface for a head of a screw element 3 (e.g. for a head of a cylinder head screw) (see FIG. 5). The first mounting flange 11a and the second mounting flange 11b may be connected or screwed together by means of screw elements 3 which are guided through the respective second holes and screwed into the respective threads of the first holes. For a pressure-tight connection of the first and second mounting flanges 11a, 11b, they may also each comprise corresponding sealing surfaces. For example, the first mounting flange 11a may comprise a first sealing surface and the second mounting flange 11b may comprise a second sealing surface. The first sealing surface and the second sealing surface may each be configured to receive a double flange seal (e.g. in the form of a metal sealing ring) and/or each comprise a cutting edge for pressing into the or a double flange seal. Accordingly, the first and second mounting flanges 11a, 11b may be connected to each other (e.g. pressure tightly) via a double flange seal (e.g. in contact with the respective sealing surfaces). In other words, the optical fiber feedthrough 10 may further comprise a double flange seal arranged between the first and second mounting flanges 11a, 11b and into which the respective cutting edges of the first and second mounting flanges 11a, 11b are preferably pressed.

The first mounting flange 11a and the second mounting flange 11b may further comprise mounting holes for fastening the first and second mounting flanges 11a, 11b to the vacuum chamber 30. For example, the first mounting flange 11a may comprise first (e.g., fully penetrating the first mounting flange 11a) mounting holes (e.g., non-threaded through holes) and the second mounting flange 11b may comprise second (e.g., fully penetrating the second mounting flange 11b) mounting holes (e.g., non-threaded through holes). The first and second mounting holes may be arranged in pairs in alignment with each other. The first and second mounting holes may form the mounting flange hole circle for fastening the at least one mounting flange 11a, 11b to the vacuum chamber 30. For example, the first mounting holes may be arranged between two of the first holes of the first hole circle and the second mounting holes may be arranged between two of the second holes of the second hole circle (see FIG. 1).

The first mounting flange 11a and the second mounting flange 11b may be spaced from each other at least in sections. Accordingly, a (e.g. evacuable) gap 16 may be arranged or provided between the first mounting flange 11a and the second mounting flange 11b (see, for example, FIGS. 3-5). This gap 16 may be delimited at least in sections by the first and second mounting flanges 11a, 11b. Furthermore, the gap 16 may be delimited by the double flange seal. Further, the gap 16 may not be configured to be rotationally symmetric. For example, an upper portion of the gap 16 may have a smaller extent (in the axial direction) than a lower portion of the gap 16. The gap 16 may be evacuated (e.g. by means of a vacuum pump, in particular a rotary vane pump). For example, the gap 16 may be evacuated to a pressure below 0.1 mbar, preferably below 0.01 mbar. For this purpose, the first mounting flange 11a and/or the second mounting flange 11b may comprise a pump-down opening with a nozzle 19 for connecting a vacuum pump. The vacuum pump may be fluidically connected to the gap 16 via the pumping opening or the nozzle 19. Preferably, the nozzle 19 is configured as a KF connection piece (for receiving a KF seal).

In the event that the at least one mounting flange 11a, 11b is configured as a double flange or comprises a first mounting flange 11a and a second mounting flange 11b, the plurality of passage openings 12a, 12b may comprise a (first) plurality of first passage openings 12a and a (second) plurality of second passage openings 12b. The (first) plurality of first passage openings 12a may be arranged on the first mounting flange 11a, or the first mounting flange 11a may comprise the (first) plurality of first passage openings 12a. Further, the (second) plurality of second passage openings 12b may be arranged on the second mounting flange 11b or the second mounting flange 11b may comprise the (second) plurality of second passage openings 12b.

The first passage openings 12a and the second passage openings 12b may be aligned (e.g. in line) with each other. For example, the first passage openings 12a of the first mounting flange 11a and the second passage openings 12b of the second mounting flange 11b may be arranged in pairs in alignment with each other, preferably for receiving one of the optical fibers 1 in a straight line. Furthermore, the first passage openings 12a of the first mounting flange 11a and the second passage openings 12b of the second mounting flange 11b may be separated and/or spaced apart from each other by the gap 16. Accordingly, an optical fiber 1 received in the at least one mounting flange 11a, 11b may first extend through one of the first passage openings 12a of the first mounting flange 11a, then through the gap 16 and finally through one of the second passage openings 12a of the second mounting flange 11b.

Preferably, the respective optical fibers 1 comprise a metal sheath 1a, 1b in the portion of the first and second mounting flanges 11a, 11b or in the portions in which the respective optical fibers 1 are passed through the first and second passage openings 12a, 12b. Thus, each of the optical fibers 1 received in the optical fiber assembly 20 may comprise a, preferably two-part, metal sheath 1a, 1b. For example, each of the optical fibers 1 may comprise a first metal sheath 1a (e.g. arranged in the portion of the first mounting flange 11a) and a second metal sheath 1b (e.g. arranged in the portion of the second mounting flange 11b). The first and second metal sheaths 1a, 1b may be spaced apart from each other by an unsheathed portion of the optical fiber 1, which is preferably arranged in the portion of the gap 16. The first and second metal sheaths 1a, 1b may be bonded to the respective optical fiber 1 (e.g. using epoxy resin). Preferably, it should be ensured that the adhesive does not form an enveloping layer in the gap 16 or on the unsheathed portion of the optical fiber 1 due to the short distance between the two metal sheaths 1a and 1b. Alternatively, the first and second metal sheaths 1a, 1b may also be soldered to a metal coating (e.g. in sections) of the respective optical fiber 1. By way of example only, when optical fibers 1 having an outer diameter of 2 mm are used, the first and second metal sheaths 1a, 1b may each have an inner diameter of 3 mm. In order to facilitate insertion of the optical fibers 1 into the optical fiber feedthrough 10, the first and/or second metal sheaths 1a, 1b may be conically tapered (e.g. at a respective end portion) and/or comprise a chamfer (e.g. of) 60°.

Each of the first passage openings 12a may be provided with a first sealing receptacle 13a or comprise a first sealing receptacle 13a. Further, each of the second passage openings 12b may be provided with a second sealing receptacle 13b or comprise a second sealing receptacle 13b. Accordingly, the plurality of sealing receptacles 13a, 13b may comprise a (first) plurality of first sealing receptacles 13a and a (second) plurality of second sealing receptacles 13b. The first sealing receptacles 13a may each be arranged and/or configured along one of the first passage openings 12a of the first mounting flange 11a. Furthermore, the second sealing receptacles 13b may each be arranged and/or configured in one of the second passage openings 12b of the second mounting flange 11b.

A first sealing element 14a may be arranged and/or received in each of the first sealing receptacles 13a (see FIG. 4). Correspondingly, a second sealing element 14b may be arranged and/or received in each of the second sealing receptacles 13b. Thus, the plurality of sealing elements 14a, 14b may comprise a (first) plurality of first sealing elements 14a and a (second) plurality of second sealing elements 14b. The first sealing elements 14a and the second sealing elements 14b may be configured as identical parts. However, the first sealing elements 14a and second sealing elements 14b may also be configured differently. For example, the first sealing elements 14a may each be made of metal and the second sealing elements 14b may each be made of Viton. Furthermore, for example, the first sealing elements 14a may each be configured as (e.g. one-piece) sealing rings (e.g. sealing O-rings) and the second sealing elements 14b may each be configured in multiple parts (e.g. each comprising two (second) end portions 14b.1, 14b.2 and one (second) sealing sleeve 14b.3).

In the event that the at least one mounting flange 11a, 11b is configured as a double flange or comprises a first mounting flange 11a and a second mounting flange 11b, the at least one compression device 15a, 15b may comprise a first compression device 15a and a second compression device 15b. The first compression device 15a may be associated to the first mounting flange 11a and/or fastened to the first mounting flange 11a. For example, the first compression device 15a may be arranged (at least in sections) on an (inner) side of the first mounting flange 11a facing the interior of the vacuum chamber 30. In contrast, the second compression device 15b may be associated with the second mounting flange 11b and/or fastened to the second mounting flange 11b. For example, the second compression device 15b may be arranged (at least in sections) on an (outer) side of the second mounting flange 11b facing the environment.

The first and second compression devices 15a, 15b may each comprise the components already described above, the suffix “first” being intended to indicate that the corresponding component is arranged on or associated with the first mounting flange 11a, and the suffix “second” being intended to indicate that the corresponding component is arranged on or associated with the second mounting flange 11b. Therefore, in order to avoid repetition, individual aspects will be discussed again below by way of example only.

For example, the first compression device 15a may comprise a first compression plate 15a.1. The first compression plate 15a.1 may be fastened (e.g. detachably) to the first mounting flange 11a and/or comprise a plurality of first through holes for the plurality of optical fibers 1. Furthermore, the second compression device 15b may also comprise a second compression plate 15b.1. The second compression plate 15b.1 may be fastened (e.g. detachably) to the second mounting flange 11b and/or comprise a plurality of second through holes for the plurality of optical fibers 1. Preferably, the first and second through holes are aligned in pairs so that each of the optical fibers 1 can be or is passed in a straight line through one of the first through holes and one of the second through holes.

Furthermore, the first compression device 15a may comprise a first plurality of first interposed sleeves 15a.2 (see FIG. 4). Here, one of the first interposed sleeves 15a.2 may be arranged in each of the first passage openings 12a. For example, each of the first interposed sleeves 15a.2 may be arranged between the first compression plate 15a.1 and one of the first sealing elements 14a. In addition or alternatively, the second compression device 15b may also comprise a second plurality of second interposed sleeves 15b.2. In each case, one of the second interposed sleeves 15b.2 may be arranged in each of the second passage openings 12b. For example, each of the second interposed sleeves 15b.2 may be arranged between the second compression plate 15b.1 and one of the second sealing elements 14b.

In order to improve tightness, the first compression device 15a may comprise a plurality of further first sealing elements (not shown) and/or a plurality of further first interposed sleeves (not shown). Here, each of the first passage openings 12a may be provided with one of the further first sealing elements and/or one of the further first interposed sleeves. In addition or alternatively, the second compression device 15b may also comprise a plurality of further second sealing elements 14b′ (e.g. O-rings and/or C-rings) and/or a plurality of further second interposed sleeves 15b.2′. Each of the second passage openings 12a may be provided with one of the further second sealing elements 14b′ and/or one of the further second interposed sleeves 15b.2′.

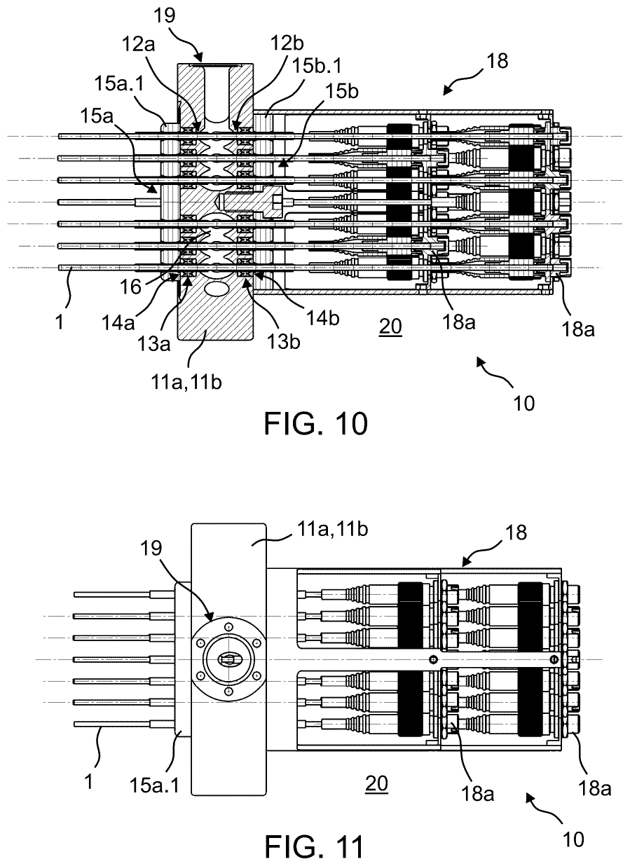

In a further embodiment, which is described in more detail with reference to FIGS. 9-21, it is also possible for the double flange to be integrally formed in one piece. Instead of a mechanical connection of the first and second mounting flanges 11a, 11b as described above, the at least one mounting flange 11a, 11b or the double flange may be manufactured, for example, using 3D printing technology or additive manufacturing. The first and second mounting flanges 11a, 11b may thus be manufactured “virtually from a single mold” and/or be integrally connected to each other in one piece. In this variant, the first and second hole circles and the double flange seal may then be omitted or not present. However, the other features described above may also be present in the case where the at least one mounting flange 11a, 11b is integrally formed in one piece. In particular, as can be seen, for example, in FIGS. 10, 14, 15 and 16, the gap 16 should preferably still be present. In other words, the at least one mounting flange 11a, 11b may be formed in one piece and comprise an evacuable gap 16, which is preferably formed within the at least one mounting flange 11a, 11b. As mentioned above, the first passage openings 12a of the at least one mounting flange 11a and the second passage openings 12b of the at least one mounting flange 11a may be separated and/or spaced apart from each other via this gap 16.

In order to accommodate the highest possible number of optical fibers 1 in the optical fiber feedthrough 10, the plurality of optical fiber couplings 18a of the coupling device 18 may further be arranged offset from each other in multiple (e.g. two) planes, as shown for the exemplary case of a CF63 flange in FIGS. 9-11 and 20 and 21. For example, a first subset (e.g., twenty) of the plurality of optical fiber couplings 18a may comprise a smaller distance from the second compression plate 15b.1 than a second subset (e.g., sixteen) of the plurality of optical fiber couplings 18a.

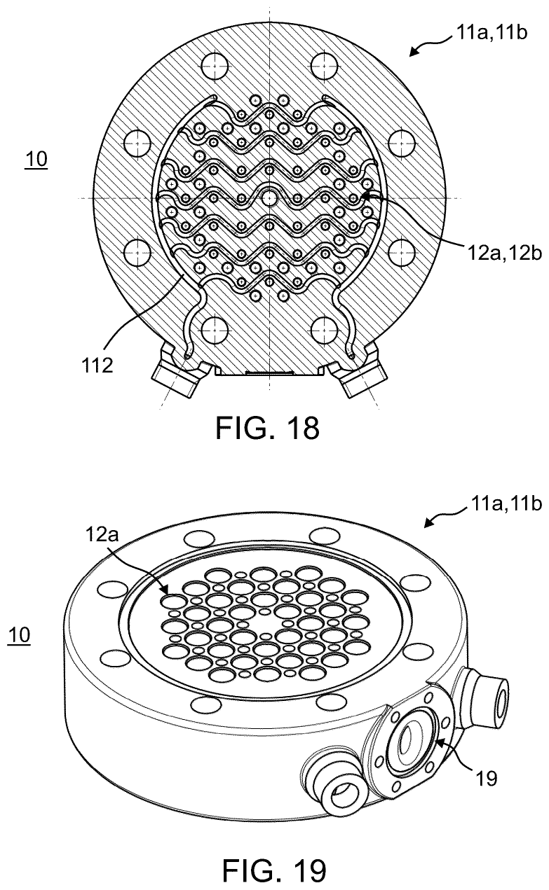

Furthermore, it is possible that the at least one mounting flange 11a, 11b may comprise a cooling channel 112 (see FIGS. 17-21). A preferably liquid cooling medium (e.g. water) may flow through the cooling channel 112. For this purpose, the at least one mounting flange 11a, 11b may comprise corresponding connections for the connection of cooling lines, the connections being fluidically connected to the cooling channel 112. The cooling channel 112 may be arranged inside the at least one mounting flange 11a, 11b or inside the first and/or second mounting flange 11a. The cooling channel 112 may, for example, be introduced (e.g. printed) into the at least one mounting flange 11a, 11b in the course of additive manufacturing. The cooling channel 112 may have a diameter of approximately 1.5 mm at the sealing receptacles 13a, 13b. The cooling channel 112 may meander within the at least one mounting flange 11a, 11b and/or branch out into a cooling channel network (see FIG. 18). By way of example only, the cooling channel network may comprise two (e.g. arcuate) main cooling channels that are fluidically connected to one another via several (e.g. meandering) cooling channel branches. By actively cooling the sealing points, low-melting-point materials (e.g. soft solder) may be advantageously used to seal or coat the optical fibers 1, which would otherwise be damaged during an assembly and/or bakeout process.

In order to facilitate the insertion of the optical fiber feedthrough 10 into the vacuum chamber 30 or into the vacuum flange of the vacuum chamber 30, the optical fiber feedthrough 10 may further comprise-irrespective of the specific design of the at least one mounting flange 11a, 11b-a tube section 111 extending away from the optical fiber feedthrough 10 (e.g. in the direction of the vacuum chamber 30) (see FIGS. 3 and 5). For example, the tube section 111 may comprise a first end portion that is connected (e.g., detachably) to the first mounting flange 11a and/or the first compression plate 15a.1 of the first mounting flange 11a, and a free second end portion. The tube section 111 may surround the first compression plate 15a.1 and/or the optical fibers 1 at least in sections (e.g. circumferentially). Accordingly, the tube section 111 may serve to protect the optical fibers 1 during assembly/disassembly.

Furthermore, the optical fiber feedthrough 10 may comprise a support device 17 (see FIGS. 3 and 5). Preferably, the support device 17 is used for (additional) support and/or mounting of the optical fibers 1. For this purpose, the support device 17 may be arranged at a distance from the first mounting flange 11a on the side of the vacuum chamber 30. Preferably, the support device 17 thus has a greater distance from the second mounting flange 11b than from the first mounting flange 11a. The support device 17 may, for example, be configured as a support plate and/or be made of polyetheretherketone. The support device 17 may be connected to the first mounting flange 11a and/or to the first compression plate 15a.1 of the first mounting flange 11a via the tube section 111. By way of example only, the support device 17 may be screwed to the tube section 111 (e.g. in the portion of rounded corners of the support device 17). Accordingly, the tube section may surround the support device 17 at least in sections (e.g. circumferentially). The support device 17 may comprise a plurality of support openings 17a for receiving the optical fibers 1. Preferably, the support openings 17a are aligned with the first passage openings 12a of the first mounting flange 11a and the second passage openings 12b of the second mounting flange 11b. Accordingly, the respective optical fibers 1 may each extend in a straight line through one of the support openings 17a of the support device 17, one of the first passage openings 12a of the first mounting flange 11a and one of the second passage openings 12b of the second mounting flange 11b. By providing the support device 17, movements of the optical fibers 1 or mechanical loads in the bonding area of the optical fibers 1 can be advantageously avoided as much as possible.

Furthermore, the optical fiber feedthrough 10 may comprise a coupling device 18 (e.g. an FC connector coupling device) (see FIGS. 1 to 5). Preferably, the coupling device 18 serves to connect or couple the optical fibers 1 to (external) further optical fibers. For this purpose, the coupling device 18 may be arranged at a distance from the second mounting flange 11b on sides of the exterior of the vacuum chamber 30. Preferably, the coupling device 18 thus has a greater distance from the first mounting flange 11a than from the second mounting flange 11b. In this case, the coupling device 18 may be fastened to the second mounting flange 11b and/or to the compression plate 15b.1 of the second mounting flange 11b via an extension (e.g. in the form of a hollow profile and/or sheet metal housing). The coupling device 18 may further comprise a plurality of optical fiber couplings 18a (e.g. in the form of corresponding sockets) for connecting the external optical fibers (e.g. for connecting external optical fiber connectors). For example, the coupling device 18 may comprise a retaining plate to which the optical fiber couplings 18a are fastened (e.g. by means of countersunk screws). By way of example only, the optical fiber couplings 18a may each be configured as FC couplings and/or for configuration of a plug-in connection with FC connectors. The optical fibers 1 may each comprise an FC connector, which are connected to the respective optical fiber couplings 18a, for example, on a side of the coupling device 18 facing the vacuum chamber 30 or the at least one mounting flange 11a, 11b. Furthermore, on a side of the coupling device 18 facing the exterior, the respective optical fiber couplings 18a can be connectable to FC connectors of the external optical fibers. Preferably, the optical fiber couplings 18a are aligned with the first passage openings 12a of the first mounting flange 11a, the second passage openings 12b of the second mounting flange 12b and/or the support openings 17a of the support device 17.

Although the invention has been described with reference to specific embodiments, it is apparent to those skilled in the art that various modifications may be made and equivalents may be used as substitutes without departing from the scope of the invention. Consequently, the invention is not intended to be limited to the disclosed embodiments, but is intended to encompass all embodiments falling within the scope of the appended claims. In particular, the invention also claims protection for the subject matter and features of the subclaims independent of the referenced claims. All portions herein are to be understood as disclosed in such a way that, as it were, all values falling within the respective portion are disclosed individually, e.g. also as respective preferred narrower outer limits of the respective portion.

What is claimed is:

1. An optical fiber feedthrough configured to feed through a plurality of optical fibers between an interior of an evacuatable vacuum chamber and an exterior of the vacuum chamber, comprising:
at least one mounting flange, which is configured for pressure-tight fastening to the vacuum chamber and comprises a plurality of passage openings, each of which is configured for pressure-tightly receiving a respective optical fiber of the plurality of optical fibers, wherein
the passage openings are each provided with a sealing receptacle and a sealing element which is arranged in the sealing receptacle for pressure-tightly receiving the respective optical fiber, and
a compression device is connected to each said at least one mounting flange, which compression device is configured to compress respective sealing elements axially along the passage openings.

2. The optical fiber feedthrough according to claim 1, wherein:
the at least one mounting flange comprises a first mounting flange configured for pressure-tight fastening to the vacuum chamber, and a second mounting flange pressure-tightly fastened to the first mounting flange.

3. The optical fiber feedthrough according to claim 2, wherein:
first passage openings of the first mounting flange of the plurality of passage openings and second passage openings of the second mounting flange of the plurality of passage openings are aligned with each other.

4. The optical fiber feedthrough according to claim 2, wherein:
an evacuatable gap is provided between the first mounting flange and the second mounting flange.

5. The optical fiber feedthrough according to claim 2, further comprising:
a support device arranged on sides of the vacuum chamber at a distance from the first mounting flange and comprising a plurality of support openings aligned with first passage openings of the first mounting flange and second passage openings of the second mounting flange.

6. The optical fiber feedthrough according to claim 2, further comprising:
a coupling device arranged at a distance from the second mounting flange on sides of the exterior of the vacuum chamber and comprising a plurality of optical fiber couplings for connecting external optical fibers, which are aligned with first passage openings of the first mounting flange and second passage openings of the second mounting flange.

7. The optical fiber feedthrough according to claim 1, wherein each compression device comprises at least one of:
a compression plate fastened to a respective mounting flange; and
a plurality of interposed sleeves for transmitting compressive force from the compression plate to the respective sealing elements.

8. The optical fiber feedthrough according to claim 7, wherein
a further sealing element and a further interposed sleeve are arranged in each of the passage openings.

9. The optical fiber feedthrough according to claim 7, comprising at least one of the features:
each of the interposed sleeves comprises a chamfer on a side of a respective interposed sleeve facing a respective sealing element; and
each of the further interposed sleeves comprises a further chamfer on a further side of the respective further interposed sleeve facing the respective further sealing element.

10. The optical fiber feedthrough according to claim 1, comprising at least one of the features:
the respective sealing elements comprise at least one of an elastomer and a metal; and
the respective sealing elements each comprise a sealing ring.

11. The optical fiber feedthrough according to claim 1, wherein:
the respective sealing elements each comprise two end portions and a sealing sleeve arranged between the two end portions.

12. The optical fiber feedthrough according to claim 11, comprising at least one of the features:
the sealing sleeve comprises polytetrafluoroethylene;
the sealing sleeve is manufactured using 3D printing technology;
the sealing sleeve has an essentially X-shaped cross-section;
the end portions each have an annular shape;
the end portions each comprise a closed shape;
the end portions are each wedge-shaped at least in sections and engage in the sealing sleeve.

13. An optical fiber assembly configured for pressure-tight fastening to a vacuum chamber, comprising:
the optical fiber feedthrough according to claim 1, and
a plurality of optical fibers, each arranged in one of the passage openings.

14. The optical fiber assembly according to claim 13, wherein:
the optical fibers of the plurality of optical fibers each comprise a metal sheath in a portion of the optical fiber feedthrough.

15. The optical fiber assembly according to claim 13, wherein
no optical fibers are arranged in a passage opening subset of the plurality of passage openings, and
pressure-tight blind plugs are arranged in the passage opening subset.

16. A method for feeding through a plurality of optical fibers between an interior of an evacuatable vacuum chamber and an exterior of the vacuum chamber, wherein the optical fiber feedthrough according to claim 1 is used, comprising the steps of
positioning optical fibers of the plurality of optical fibers in the passage openings of the at least one mounting flange,
compressing the sealing elements in the sealing receptacles of the passage openings axially along the respective passage openings, and
evacuating the vacuum chamber.
